(19) United States
(12) Patent Application Publication
(10) Pub. No.: US 2020/0047166 A1
(43) Pub. Date: Feb. 13, 2020

(54) IRON CARBIDE NANOPARTICLES, METHOD FOR PREPARING SAME AND USE THEREOF FOR HEAT GENERATION

(71) Applicants: INSTITUT NATIONAL DES SCIENCES APPLIQUEES DE TOULOUSE, Toulouse (FR); CENTRE NATIONAL DE LA RECHERCHE SCIENTIFIQUE, Paris (FR)

(72) Inventors: Alexis BORDET, Toulouse (FR); Aikaterini SOULANTIKA, Clermont Le Fort (FR); Bruno CHAUDRET, Vigoulet Auzil (FR)

(21) Appl. No.: 16/062,994

(22) PCT Filed: Dec. 15, 2016
(86) PCT No.: PCT/FR2016/053451

§ 371 Date: Jun. 15, 2018

(30) Foreign Application Priority Data
Dec. 18, 2015 (FR) 1562763

(51) Int. Cl. B01J 27/22; B01J 35/02; B01J 23/745; B01J 37/08; B01J 35/00

(52) U.S. Cl. CPC B01J 27/22; B01J 35/023; B82Y 40/00; B01J 37/086; B01J 35/0033; B01J 23/745

(57) ABSTRACT

Disclosed are iron nanoparticles, in which at least 70% of the iron atoms they contain are present in an Fe2,2C crystalline structure. In particular, these nanoparticles can be obtained via the carburization of zero-valent iron nanoparticles, by contacting the iron nanoparticles with a gas mixture of dihydrogen and carbon monoxide. The iron carbide nanoparticles are particularly suitable to be used for hyperthermia and for catalyzing Sabatier and Fischer-Tropsch reactions.

The present invention lies in the field of ferromagnetic nanoparticles. More particularly, it relates to iron carbide nanoparticles, and also to a method for preparing such nanoparticles. The invention also relates to the use of such nanoparticles for heat production, and also for the catalysis of chemical reactions, in particular for the catalysis of the reaction for reducing carbon dioxide or carbon monoxide to hydrocarbon(s).

In the present description, the term “nanoparticles” is intended to mean particles having a size of between approximately 1 nm and approximately 100 nm.

Magnetic nanoparticles are used in many fields, taking advantage of their entirely advantageous properties, such as the microelectronics field, the nanoelectronics field, the magnet field, but also the biomedicine field, the chemical catalysis field, etc.

Ferromagnetic nanoparticles have been the subject of many studies. Among them, iron carbide nanoparticles prove to be very attractive owing to their combined properties of good air-stability and of strong magnetization. They are thus considered to have a high potential in particular for energy conversion and storage, nanomagnets and nanomedicine. Among their numerous applications, mention may more specifically be made of magnetic hyperthermia and chemical reaction catalysis, which take advantage of the capacity of ferromagnetic nanoparticles, subjected to a magnetic field, to convert external energy into heat. The power generated by magnetic nanoparticles is governed by their specific absorption rate (SAR).

By way of reactions that might be catalyzed by ferromagnetic nanoparticles, whether they are iron-based, cobalt-based or nickel-based nanoparticles, mention may in particular be made of Sabatier reactions and Fischer-Tropsch reactions, corresponding to the following reaction schemes, which are conventional in themselves:

CO₂+4H₂→CH₄+2H₂O Sabatier reaction:

2(n+1)H₂+nCO→CₙH₂ₙ₊₂+nH₂O Fischer-Tropsch reaction:

The Sabatier and Fischer-Tropsch reactions can be used for energy storage, by catalytic reduction of carbon oxides to hydrocarbons: in the presence of hydrogen, for example produced from photovoltaic or wind energy, and of a catalyst comprising a ferromagnetic metal such as iron, cobalt, nickel or alloys thereof, or of a catalyst comprising a noble metal such as ruthenium, rhodium or alloys thereof, carbon dioxide is converted into methane (Sabatier reaction) and carbon monoxide is converted into higher hydrocarbons (Fischer-Tropsch process). The Fischer-Tropsch reaction is in particular considered to be the most practical approach for producing liquid fuels from fossil resources such as natural gas and coal, and also biogas from biomass.

It has thus been proposed by the prior art to use ferromagnetic nanoparticles for catalyzing such reactions, taking advantage of the capacity of these nanoparticles to produce heat when they are activated by magnetic induction. The activated catalytic nanoparticle is heated by the reversal of its own magnetic moment, and its temperature rapidly increases, so that the catalysis reaction initiates at its surface, without the reaction medium as a whole having reached the critical reaction temperature. Very high local temperatures are thus achieved, enabling the catalysis of the chemical reaction, this being at a low energy cost.

The use of ferromagnetic nanoparticles for the catalysis of chemical reactions, in particular of reactions for conversion of dihydrogen and of carbon monoxide or dioxide to another chemical form, and as a result the conversion of the electrical energy produced locally into energetic compounds, such as hydrocarbons, which can be used directly in thermal systems, has for example been described in patent document WO-A-2014/162099.

The prior art has proposed various types of iron carbide nanoparticles for carrying out such a catalysis.

For example, the publication by Yang et al., 2012, J. Am. Chem. Soc., 134, 15814-15821 has in particular proposed iron carbide nanoparticles composed of the Fe₅C₂ crystalline phase, or else the publication by Meffre et al., 2012, Nano Letters 12, 4722-4728 has in particular proposed iron carbide nanoparticles in the form of a mixture of amorphous and crystalline phases including Fe_{2.2}C and Fe₅C₂, said nanoparticles being obtained from iron carbonyl Fe(CO)₅, with a view to the catalysis of the Fischer-Tropsch reaction.

Nanoparticles of the type having a Fe₃C—C core-shell structure have also been proposed by the prior art, as illustrated in particular in the publication by Liu et al., 2015, Nanotechnology 26, 085601.

Underlying the present invention it was discovered by the present inventors that iron carbide nanoparticles having a particular structure, and in particular a crystalline phase consisting solely of Fe_{2.2}C, and a particular Fe_{2.2}C content, exhibit, entirely unexpectedly, a particularly high heating capacity, much higher than that of the iron carbide nanoparticles of the prior art, and including when they are activated by weak magnetic fields. Even more unexpectedly, these nanoparticles are capable, when they are activated by magnetic induction, of catalyzing by themselves Sabatier and Fischer-Tropsch reactions, for the production of hydrocarbons, in particular of methane, from dihydrogen, this being without having recourse to any other catalyst.

The present invention thus aims to provide iron carbide nanoparticles having, when they are activated by magnetic induction, a high heating capacity, which is in particular improved compared with the ferromagnetic nanoparticles proposed by the prior art.

An additional objective of the invention is for this heating capacity to be able to be exerted under a magnetic field of low amplitude, so as to make energy savings.

Another target of the invention is for these nanoparticles to be able to be prepared by means of a method which is easy and rapid to carry out, and which also allows precise control of the amount of carbon present in the iron core of the nanoparticle. Another objective of the invention is for this preparation method not to use dangerous halogenated compounds which are difficult to handle.

To this effect, according to a first aspect, the present invention provides an iron carbide nanoparticle, of the homogeneous phase type or core-shell structure type, and comprising a crystalline structure of Fe_{2.2}C, in which at least 70%, preferably at least 75%, and preferentially at least 80%, by number, of the iron atoms that it contains are present in said Fe_{2.2}C crystalline structure.

In other words, the nanoparticle according to the invention comprises at least 70 mol %, preferably at least 75 mol %, and preferentially at least 80 mol %, relative to the total number of moles of iron in the nanoparticle, of iron participating in the Fe_{2.2}C crystalline phase.

The content, in the nanoparticle, of iron atoms involved in the Fe_{2.2}C crystalline structure can be determined by any method which is conventional in itself for those skilled in the art, for example by Mössbauer spectroscopy, which makes it possible to count the relative numbers of iron atoms involved in each of the phases making up the nanoparticle.

The nanoparticle according to the invention may be of homogeneous phase, that is to say may consist solely of a crystalline structure, or may comprise a crystalline structure of Fe_{2.2}C bearing a layer which is non-stoichiometric/amorphous at the surface.

The nanoparticle according to the invention may otherwise be of the type having a core-shell structure, comprising a crystalline core formed essentially of the Fe_{2.2}C crystalline structure, this core also possibly comprising a very minor amount of pure iron atoms and/or impurities in trace form. The shell of the nanoparticle may, for its part, then be amorphous or polycrystalline.

Such a nanoparticle, when magnetic-induction-activated, advantageously has both a particularly high heating capacity, corresponding to an SAR of greater than 1 kW/g, and possibly even being greater than 3 kW/g, at 100 kHz and 47 mT, and also the capacity to heat at relatively weak magnetic fields, in particular having an amplitude as low as 25 mT. They thus make it possible to heat at high temperatures at moderate magnetic fields and frequencies, and therefore at low energy cost. Such performance levels are much greater than those obtained with the nanoparticles proposed by the prior art, whether they are iron, iron oxide or iron carbide nanoparticles.

The nanoparticles according to the invention also have the advantage of increasing and decreasing in temperature very rapidly, so that this results in an even greater energy saving when they are used.

Moreover, they have the capacity to catalyze chemical reactions requiring an input of heat, and also to catalyze by themselves the Sabatier reaction, for reducing carbon dioxide to hydrocarbons, without doping using another element such as cobalt or ruthenium.

They can more generally be used for any type of catalytic conversion in gas or liquid phase using magnetic induction as heating means.

The nanoparticles according to the invention are preferably of single domain type, that is to say of a size less than the critical size of transition between a single-domain state and a multi-domain state.

Preferentially, their size is between 1 and 20 nm, and preferably between 10 and 16 nm.

This means that each of their dimensions is between approximately 1 and approximately 20 nm, in particular between 10 and 16 nm.

Preferentially, their size is equal to 15 nm±1 nm. Such a characteristic in particular confers on the nanoparticles the highest performance levels in terms of heating capacity.

The nanoparticles according to the invention may be in any shape. The substantially spherical shape is however particularly preferred in the context of the invention.

They preferably exhibit good monodispersity. This means a size distribution of at most +/−10% relative to the mean size.

The nanoparticles according to the invention may also contain a compound which is a catalyst of a given chemical reaction, such as a catalytic metal, which is present on at least one part of their surface, so as to improve their catalytic activity for this particular chemical reaction, by a combination of physical properties and chemical properties allowing them to act both as a catalyst for the reaction and as a supplier of the thermal energy required for the reaction, after stimulation by magnetic induction.

Thus, in particular embodiments of the invention, the iron carbide nanoparticles are covered, on at least part of their surface, with a coating of a catalytic metal.

The composition of such a coating is advantageously chosen so as to make it possible, depending on the particular chemical reaction targeted, to catalyze this reaction, to increase its yield and/or to improve its selectivity.

In particular configurations of the nanoparticles according to the invention, in which the coating of catalytic metal entirely covers the surface of the nanoparticles, the catalytic metal acts as a catalyst for the chemical reaction, the iron carbide supplying to it the thermal energy required for this purpose.

In other particular configurations of the nanoparticles according to the invention, in which the coating of catalytic metal covers only part of the surface of the nanoparticles, the iron carbide is exposed to the reaction medium, and can act as both a catalyst for the chemical reaction and a source of thermal energy for its own catalytic action, and also for the combined catalytic action of the catalytic metal.

The catalytic metal may in particular be chosen from nickel, ruthenium, cobalt, copper, zinc, platinum, palladium, rhodium, or else manganese, molybdenum, tungsten, vanadium, iridium or gold, or any one of the alloys thereof, these elements/alloys being taken alone or as a mixture, for example in the form of a copper/zinc mixture.

For the catalysis of the Sabatier reaction and/or of the Fischer-Tropsch reaction, the performance level of the iron carbide nanoparticles according to the invention can in particular be improved by depositing nickel on their surface.

The iron carbide nanoparticles according to the invention can in particular be obtained by means of a step of carburization of zero-valent iron nanoparticles, by bringing these zero-valent iron nanoparticles into contact with a gas mixture of dihydrogen and carbon monoxide.

In particular embodiments of the invention, the iron carbide nanoparticle is supported on a solid support.

This solid support is in particular in pulverulent form.

This solid support is chosen so as, on the one hand, to be inert with respect to the reaction for which the nanoparticles according to the invention are intended to be used, and on the other hand, to ensure that the nanoparticles are properly held in place during this reaction. The solid support can in particular be made of a material chosen from microporous or mesoporous metal oxides, carbon, or any one of the mixtures or alloys thereof. It may for example be made of aluminosilicate, such as the Siralox® support sold by the company Sasol, or else of zirconium oxide, of cerium oxide, etc.

The degree of loading of the solid support with the nanoparticles according to the invention can in particular be between 1% and 50% by weight of iron, relative to the total weight of the support.

The solid support may moreover, optionally, be doped with a catalytic metal. This catalytic metal can in particular be chosen from nickel, ruthenium, cobalt, copper, zinc, platinum, palladium, rhodium, or else manganese, molybdenum, tungsten, vanadium, iridium or gold, or any one of the alloys thereof, taken alone or as a mixture, for example in the form of a copper/zinc mixture.

The solid support may also, optionally, be doped with a doping agent which is conventional in itself for the intended chemical catalysis reaction, such as an alkali metal agent, an alkaline-earth metal agent, etc., or a mixture of such doping agents.

According to a second aspect, the present invention relates to a preparation method for preparing iron carbide nanoparticles according to the invention, which can have one or more of the above characteristics. This method comprises a step of carburization of zero-valent iron nanoparticles, by bringing said zero-valent iron nanoparticles into contact with a gas mixture of dihydrogen and carbon monoxide. The implementation of such a carburization step advantageously makes it possible to obtain iron carbide nanoparticles of core-shell structure, the core of which is a crystalline core composed exclusively of Fe_{2.2}C.

Such a carburization step also proves to be entirely advantageous in that it makes it possible, through an appropriate choice of its operating parameters, to accurately control the amount of carbon introduced into the zero-valent iron nanoparticles, and therefore the molar amount of Fe_{2.2}C crystalline phase in the nanoparticle, and to thus influence the characteristics of the nanoparticles which determine their heating capacity.

According to particular embodiments of the invention, the method for preparing the nanoparticles also has the following characteristics, implemented separately or in each of their technically effective combinations.

In particular embodiments of the invention, the carburization step is carried out at a temperature of between 120 and 300° C., preferably between 120 and 180° C., and preferentially approximately 150° C. Temperatures above 300° C. induce in particular a phase change, and lead to the obtaining of a high content of Fe₅C₂ crystalline structure, which is contrary to the present invention.

The carburization step is preferably carried out for a period of between 72 and 200 h. In this range, the choice of the exact duration of the carburization step makes it possible to control the carbon content of the nanoparticles and, as a result, their hyperthermic properties.

In particular embodiments of the invention, the carburization step comprises the removal of the water formed during the reaction of the zero-valent iron nanoparticles and of the gas mixture, as said water forms.

This removal can in particular be carried out by means of a molecular sieve, of pore size suitable for trapping water molecules, placed in a zone of the reactor chosen such that it is not in contact with the nanoparticles, and not exposed to high temperatures.

The removal of the water in-situ as it forms advantageously makes it possible to accelerate the reaction of carburization of the zero-valent iron nanoparticles, and to obtain iron carbide nanoparticles in accordance with the present invention much more rapidly than in the absence of removal of the water formed during the reaction. Thus, in carburization times of between 24 and 60 h for example, nanoparticles with particularly high heating performance levels are obtained.

In general, it is within the capabilities of those skilled in the art to determine, for each of the operating parameters above and below, the exact value to be applied, in particular within the preferential ranges indicated in the present description, so as to obtain the desired particular properties for the iron carbide nanoparticles, as a function of the particular intended application.

The carburization step can be carried out by bringing the gas mixture into contact with nanoparticles either in the form of a dispersion in a solvent, preferably an aprotic organic solvent, such as mesitylene, or in powder form.

It can for example use a dihydrogen pressure of between 1 and 10 bar, preferentially of approximately 2 bar, and/or a carbon monoxide pressure of between 1 and 10 bar, preferentially of approximately 2 bar.

In particular embodiments of the invention, the method comprises a prior step of preparing the zero-valent iron)(Fe⁰ nanoparticles by decomposition of an organometallic precursor corresponding to general formula (I):

Fe(NR¹R²)(NR³R⁴) (I)
wherein R¹, R², R³ and R⁴, which may be identical or different, each represent an alkyl, aryl, trimethylsilyl or trimethylalkyl group,

in the presence of dihydrogen and of a ligand system comprising a carboxylic acid and an amine, preferably a primary amine or a secondary amine, at least one compound among this carboxylic acid and this amine comprising a C₄ to C₃₄, preferably C₈ to C₂₀, hydrocarbon-based chain.

In particular excluded, in the context of the present invention, are the precursors of general formula Fe(COT)₂ or Fe(CO)₅, or any iron carbonyl derivative, such as Fe₃(CO)₁₂, and any ferrocene Fe(Cp)₂ or any ferrocene derivative.

An organometallic precursor which is particularly preferred is the bis(trimethylsilyl)amido-iron(II) dimer.

The step of preparing the zero-valent iron nanoparticles can in particular be carried out under a dihydrogen pressure of between 1 and 10 bar, preferentially approximately equal to 2 bar.

The carboxylic acid and the amine which are contained in the ligand system can both be linear or branched or cyclic. They can be functionalized or non-functionalized, and can comprise a saturated or unsaturated chain.

In particularly preferred embodiments of the invention, the ligand system comprises palmitic acid and/or hexadecylamine, preferably the palmitic acid/hexadecylamine pair.

The method according to the invention then advantageously makes it possible to prepare, as intermediate compounds, Fe⁰ nanoparticles of substantially spherical shape which are especially monodisperse, making it possible to prepare iron carbide nanoparticles which are also substantially spherical and monodispersed. This results in extremely homogeneous heating by the carbide nanoparticles according to the invention.

Moreover, the use of such a palmitic acid/hexadecylamine ligand system advantageously makes it possible to obtain molar percentages of the Fe_{2.2}C crystalline structure in the nanoparticle which are greater than or equal to 70%, in accordance with what is recommended by the present invention.

It also makes it possible to carry out a direct carburization of the Fe⁰ nanoparticles obtained, that is to say by bringing these nanoparticles directly into contact with the gas phase.

Thus, in particular embodiments of the invention, the carburization step is carried out directly on the zero-valent iron nanoparticles obtained at the end of the decomposition step of the method.

The method according to the invention can also have one or more, preferably all, of the characteristics below, regarding the step of decomposition of the organometallic precursor so as to form the Fe⁰ nanoparticles:
the decomposition step is carried out at a temperature of between 120 and 300° C., preferably of between 120 and 180° C., and preferentially at approximately 150° C.;
the decomposition step is carried out for a period of between 1 and 72 h, preferably of approximately 48 h;
the decomposition step is carried out in an aprotic organic solvent with a boiling point above 100° C., in particular an aromatic solvent, for example toluene or mesitylene.

Such characteristics advantageously make it possible to improve the control of the properties of the nanoparticles formed.

The method according to the invention, having one or more of the characteristics above, is advantageously simple to carry out. It also proves to be more advantageous in many respects than the methods for preparing iron carbide nanoparticles proposed by the prior art, in addition to the fact that it makes it possible to prepare nanoparticles with a high content of Fe_{2.2}C crystalline structure, and that it makes it possible to accurately control the amount of carbon introduced into this crystalline structure, thus making it possible to control the Fe_{2.2}C content in the nanoparticle.

Compared with the prior art processes using a hexadecylamine/hexadecylammonium chloride ligand system, the particularly preferred embodiment of the invention using the palmitic acid/hexadecylamine system has in particular the advantage of avoiding the risks of modifying the magnetic and catalytic properties of the nanoparticles, caused by the action of chlorine.

Compared with the prior art methods using iron pentacarbonyl Fe(CO)₅ to carry out the iron nanoparticle carburization, the method according to the invention proves to be less dangerous and less difficult to carry out, and it allows a much more accurate control of the carburization and also makes it possible to obtain a core of the Fe_{2.2}C pure crystalline phase.

When it is desired to prepare iron-carbide nanoparticles at least partially surface-covered with a catalytic metal, the method according to the invention can comprise a subsequent step of treating the iron carbide nanoparticles according to the invention by bringing them into contact with an organometallic precursor of said catalytic metal, for example a nickel precursor, this bringing into contact possibly in particular, but not necessarily, being carried out in the presence of hydrogen.

Such a step of treating nanoparticles via the “organometallic” route is conventional in itself, and can be carried out in any way known to those skilled in the art.

Another aspect of the invention relates to the use of iron carbide nanoparticles according to the invention, which can have one or more of the characteristics above, for heat production, after activation by magnetic induction. The iron carbide nanoparticles can in particular be used for hyperthermia, in the biomedicine field, according to use protocols which are conventional in themselves, and which take advantage of their particularly high SAR.

The present invention also relates to the use of iron carbide nanoparticles according to the invention, which can have one or more of the characteristics above, for the catalysis of chemical reactions, always by activation by magnetic induction.

The chemical reaction can in particular be a reaction of reduction of carbon dioxide or of carbon monoxide into hydrocarbon(s), such as a Sabatier or Fischer-Tropsch reaction, which reaction the iron carbide nanoparticles according to the invention are advantageously capable of catalyzing by themselves, without the addition of an additional specific catalyst.

Thus, the nanoparticles according to the invention can advantageously be used for the chemical storage of energy in the form of hydrocarbon(s), for example in the form of methane.

For all these applications, the nanoparticles are subjected to a magnetic field with an amplitude preferentially of between 10 and 65 mT, with a frequency of between 100 and 300 kHz. The means for generating this magnetic field are conventional in themselves.

According to an additional aspect, the present invention thus relates to a catalysis method for catalyzing a chemical reaction by means of iron carbide nanoparticles according to the present invention, which can have one or more of the characteristics above. According to this method, the iron carbide nanoparticles are introduced into a reaction medium containing one or more reagents of the intended chemical reaction, and the reaction medium is subjected to a magnetic field capable of causing an increase in the temperature of the nanoparticles up to a temperature greater than or equal to a temperature required for carrying out the chemical reaction.

The activation of the nanoparticles by magnetic induction is preferably carried out using a field inducer external to the reactor in which the reaction is carried out. The term “inducer” is intended to mean any magnetic induction system comprising members generating a magnetic field, members making it possible to control the values of this magnetic field, and also its power-supplying, which may be electric or the like. In particular, the members generating the magnetic field may be placed in the reactor, in its wall, or outside the reactor.

In particular embodiments of the invention, the magnetic field is applied at a first amplitude, preferably greater than 50 mT, for a first period of time, preferably for a period of between 3 seconds and 1 minute, then at a second amplitude, lower than said first amplitude, preferably of between 20 and 40 mT, for a second period of time, said second period of time being longer than said first period of time, and preferably being greater than or equal to 4 hours. Such an embodiment proves in particular to be entirely advantageous from the point of view of the low consumption of energy required for carrying out the chemical reaction.

In particular embodiments of the invention, which are particularly suitable for the configurations in which the iron carbide nanoparticles are covered with a coating of a catalytic metal, for example of nickel, the magnetic field is applied to the reaction medium in a pulsed manner.

In particular embodiments of the invention, the nanoparticles are supported on a solid support, and the chemical reaction is carried out in continuous flow(s) of reagent(s). Thus, the nanoparticles according to the invention are placed in a reactor, and the reaction reagent(s) are entrained through this reactor in a continuous flow. The heating capacity of the nanoparticles according to the invention is then advantageously sufficiently high to make it possible to obtain a temperature suitable for the catalysis of the intended chemical reaction, despite the short contact times occurring between the nanoparticles and the reagent(s).

The method according to the invention can be used both for gas-phase catalysis, in which the reagents are in gas form, and for liquid-phase catalysis, in which the reagents are in liquid form.

Depending on the catalytic metal present at their surface, the iron carbide nanoparticles according to the invention can also be used for numerous other applications, for example, in a nonlimiting manner:
for methanol synthesis, with said nanoparticles being surface-coated with a copper/zinc Cu/Zn mixture,
for the catalysis of hydrogenation reactions, or as electrode materials, with said nanoparticles being surface-coated with palladium or with platinum,
for the catalysis of carbonylation or hydrogenation reactions, with said nanoparticles being surface-coated with rhodium,
for the catalysis of Sabatier or Fischer-Tropsch reactions, with improved selectivity, as set out above, with said nanoparticles being covered with cobalt, with nickel or with ruthenium.

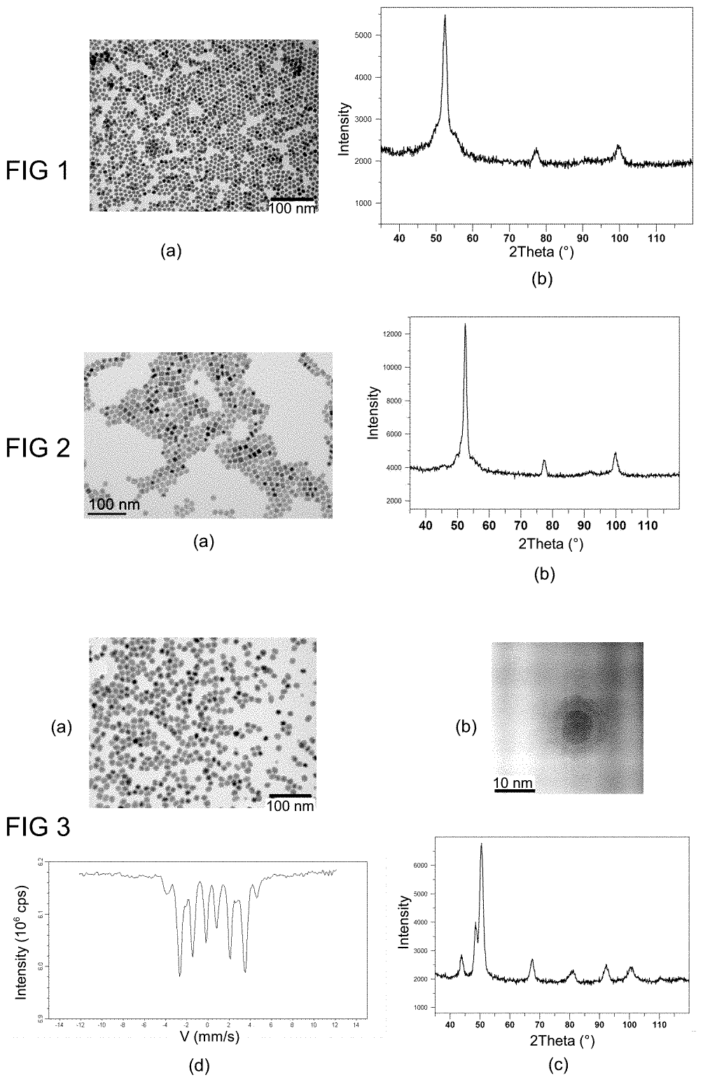

The characteristics and advantages of the invention will emerge more clearly in light of the examples of implementation below, given simply by way of illustration and which are in no way limiting with regard to the invention, with the support of FIGS. 1 to 25, wherein:

FIG. 1 shows the results of tests to characterize 9.0 nm Fe⁰ nanoparticles prepared in accordance with the invention, (a) by transmission electron microscopy, (b) by X-ray diffraction;

FIG. 2 shows the results of tests to characterize 12.5 nm Fe⁰ nanoparticles prepared in accordance with the invention, (a) by transmission electron microscopy, (b) by X-ray diffraction;

FIG. 3 shows the results of tests to characterize 13.0 nm iron carbide nanoparticles containing 80 mol % of Fe_{2.2}C in accordance with the invention, (a) and (b) by transmission electron microscopy with two different magnifications, (c) by X-ray diffraction, (d) by Mössbauer spectroscopy;

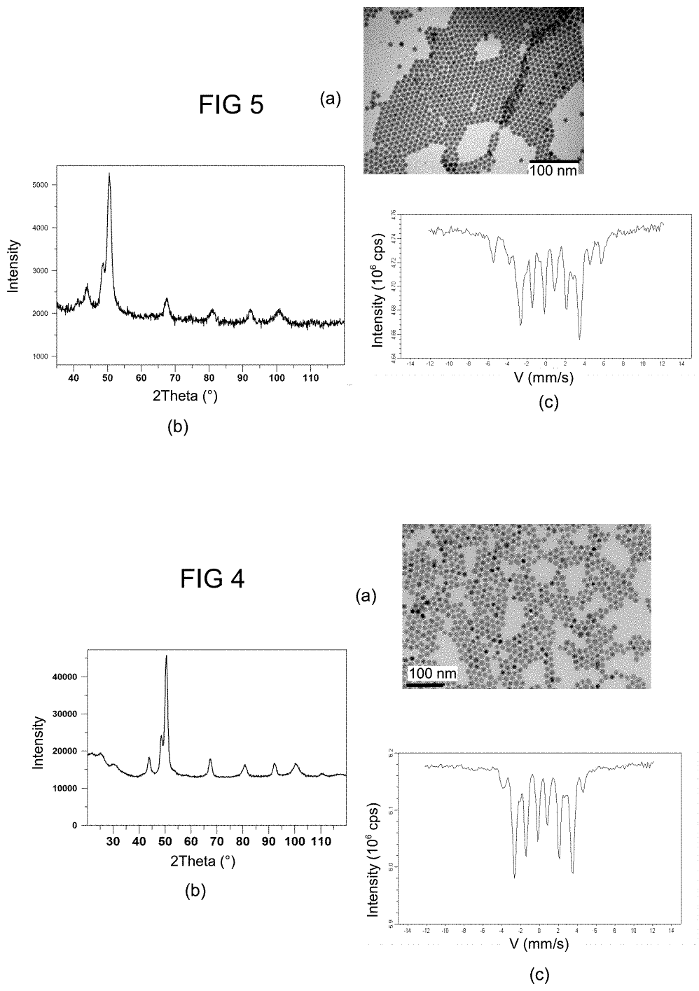

FIG. 4 shows the results of tests to characterize 15.0 nm iron carbide nanoparticles containing 80 mol % of Fe_{2.2}C in accordance with the invention, (a) by transmission electron microscopy, (b) by X-ray diffraction, (c) by Mössbauer spectroscopy;

FIG. 5 shows the results of tests to characterize 9.7 nm iron carbide nanoparticles containing 59 mol % of Fe_{2.2}C in accordance with the invention, (a) by transmission electron microscopy, (b) by X-ray diffraction, (c) by Mössbauer spectroscopy;

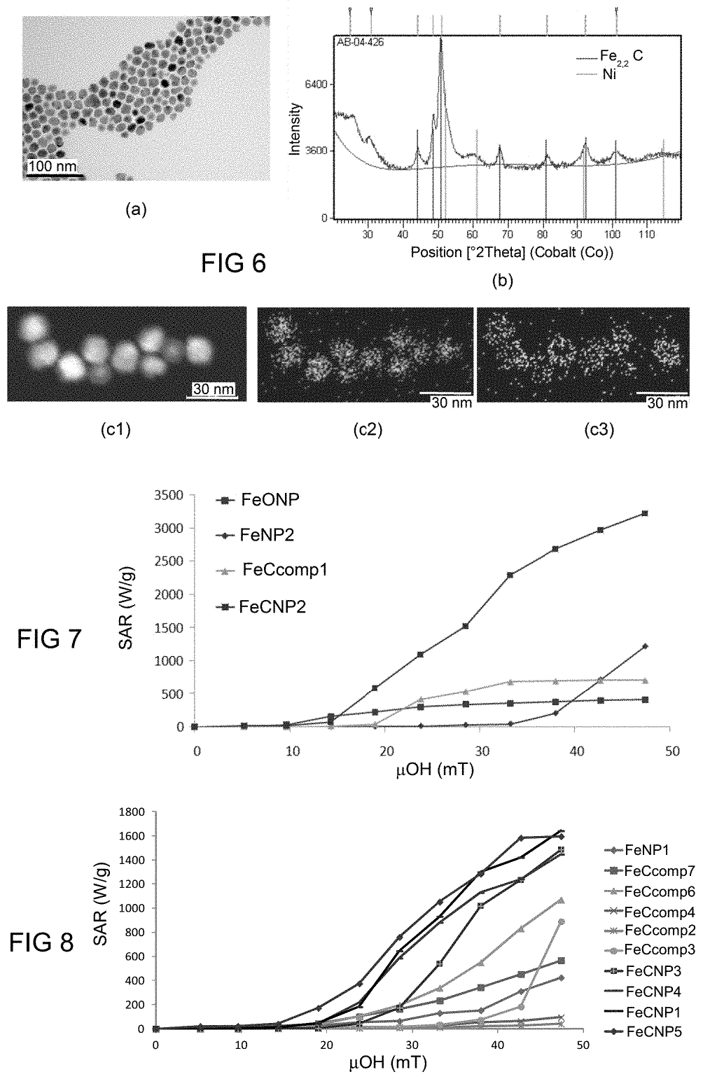

FIG. 6 shows the results of tests to characterize iron carbide nanoparticles containing 80 mol % of Fe_{2.2}C, said particles being covered with nickel, in accordance with the invention, (a) by transmission electron microscopy, (b) by X-ray diffraction, (c1) by STEM, (c2) by iron-targeted STEM-EDX and (c3) by nickel-targeted STEM-EDX;

FIG. 7 represents a graph showing the specific absorption rate (SAR), as a function of the amplitude of the magnetic field, for a hyperthermia test by magnetic induction at 100 kHz carried out on iron oxide nanoparticles of the prior art (FeONP), iron nanoparticles prepared according to a method in accordance with the invention (FeNP2), iron carbide nanoparticles in accordance with the invention (FeCNP2) and iron carbide nanoparticles according to the prior art (FeCcomp1),

FIG. 8 represents a graph showing the specific absorption rate (SAR), as a function of the amplitude of the magnetic field, for a hyperthermia test by magnetic induction at 100 kHz carried out on iron nanoparticles prepared according to a method in accordance with the invention (FeNP1), iron carbide nanoparticles in accordance with the invention (FeCNP1, FeCNP3, FeCNP4 and FeCNP5) and comparative iron carbide nanoparticles (FeCcomp2, FeCcomp3, FeCcomp4, FeCcomp6, FeCcomp7);

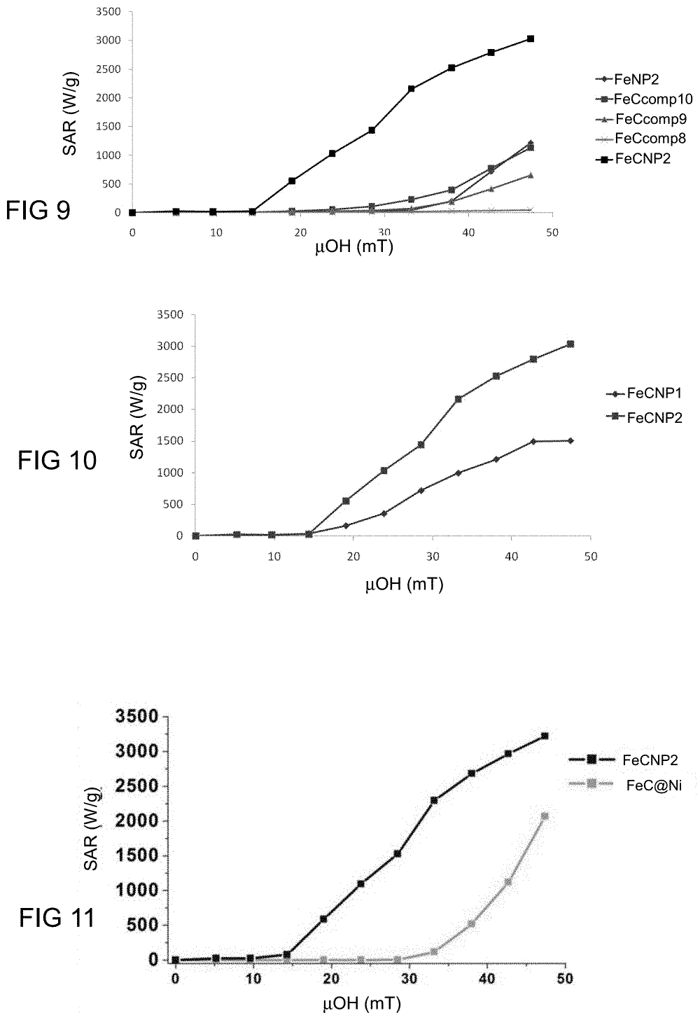

FIG. 9 represents a graph showing the specific absorption rate (SAR), as a function of the amplitude of the magnetic field, for a hyperthermia test by magnetic induction at 100 kHz carried out on iron nanoparticles prepared according to a method in accordance with the invention (FeNP2), iron carbide nanoparticles in accordance with the invention (FeCNP2) and comparative iron carbide nanoparticles (FeCcomp8, FeCcomp9, FeCcomp10),

FIG. 10 represents a graph showing the specific absorption rate (SAR), as a function of the amplitude of the magnetic field, for a hyperthermia test by magnetic induction at 100 kHz carried out on iron carbide nanoparticles in accordance with the invention of various sizes, FeCNP1 and FeCNP2;

FIG. 11 represents a graph showing the specific absorption rate (SAR), as a function of the amplitude of the magnetic field, for a hyperthermia test by magnetic induction at 100 kHz carried out on iron carbide nanoparticles in accordance with the invention (FeCNP2) and nickel-covered iron carbide nanoparticles in accordance with the invention (FeC@Ni);

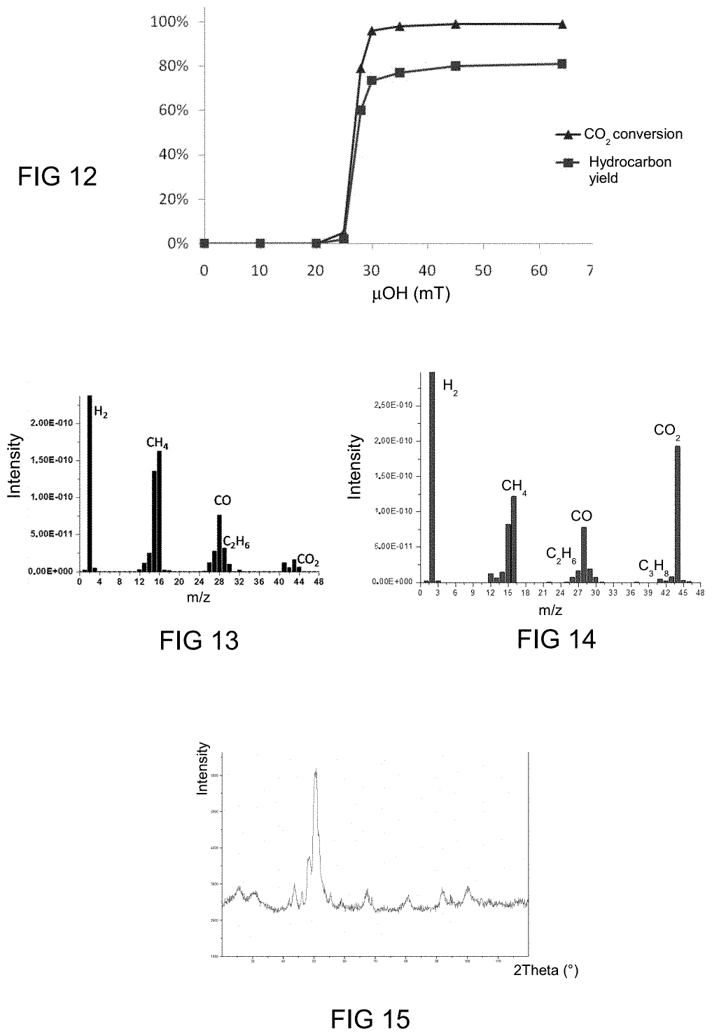

FIG. 12 represents a graph showing, on the one hand, the conversion rate of CO₂ and, on the other hand, the hydrocarbon yield, as a function of the amplitude of the magnetic field applied, during the use of iron carbide nanoparticles in accordance with the invention for the catalysis of the Sabatier reaction;

FIG. 13 shows the mass spectrum of the gas phase obtained following the use of iron carbide nanoparticles in accordance with the invention for the catalysis of the Sabatier reaction, under a magnetic field of 30 mT at 300 kHz;

FIG. 14 shows the mass spectrum of the gas phase obtained following the use of iron carbide nanoparticles in accordance with the invention for the catalysis of the Sabatier reaction, under a magnetic field of 40.2 mT at 300 kHz;

FIG. 15 shows the X-ray diffractogram of iron carbide nanoparticles in accordance with the invention following a reaction for catalysis of the Sabatier reaction, under a magnetic field of 40.2 mT at 300 kHz for 8 h;

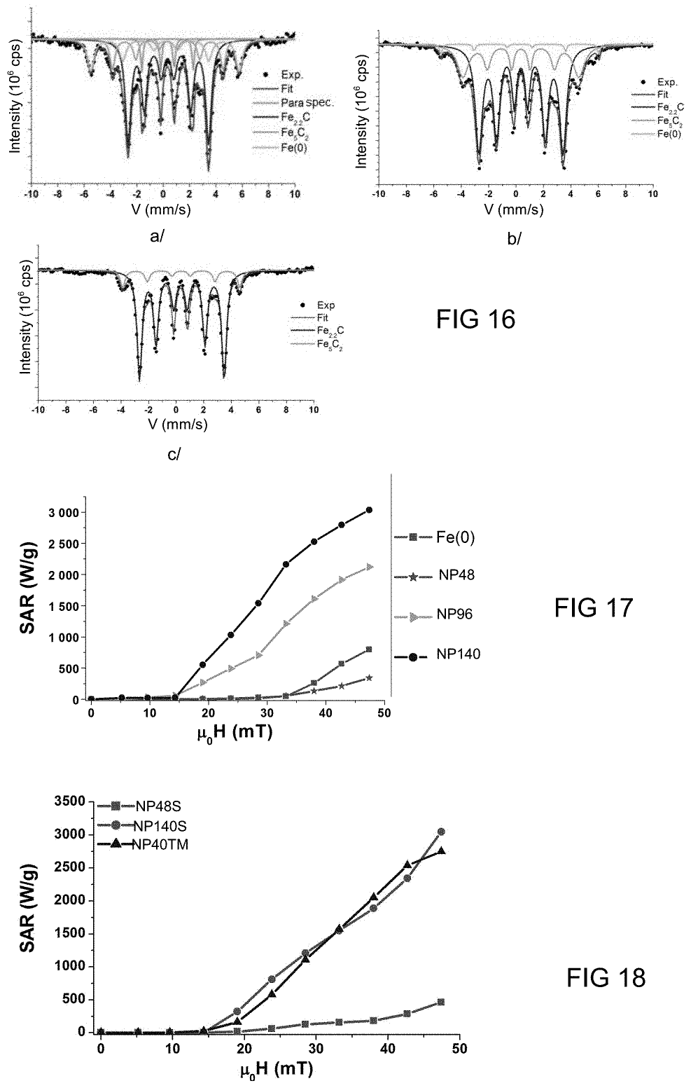

FIG. 16 shows the Mössbauer spectra obtained for nanoparticles according to the invention (b/ obtained with a carburization time of 96 h, c/ obtained with carburization time of 140 h) and for iron carbide nanoparticles prepared according to the same protocol, but with a carburization time of 48 h (a/), not in accordance with the invention;

FIG. 17 represents a graph showing the specific absorption rate (SAR), as a function of the amplitude of the magnetic field, for a hyperthermia test by magnetic induction at 100 kHz carried out on zero-valent iron nanoparticles (Fe⁰), and iron carbide nanoparticles prepared from these zero-valent iron nanoparticles: according to a method in accordance with the invention using a carburization time of 96 h (NP96) or a carburization time of 140 h (NP140), or according to a method using a carburization time of 48 h (NP48);

FIG. 18 represents a graph showing the specific absorption rate (SAR), as a function of the amplitude of the magnetic field, for a hyperthermia test by magnetic induction at 100 kHz carried out on iron carbide nanoparticles prepared: according to a method in accordance with the invention using, for the carburization step, a molecular sieve and a carburization time of 40 h (NP40TM) or no molecular sieve and a carburization time of 140 h (NP140S), or according to a method using a carburization time of 48 h without molecular sieve (NP48S);

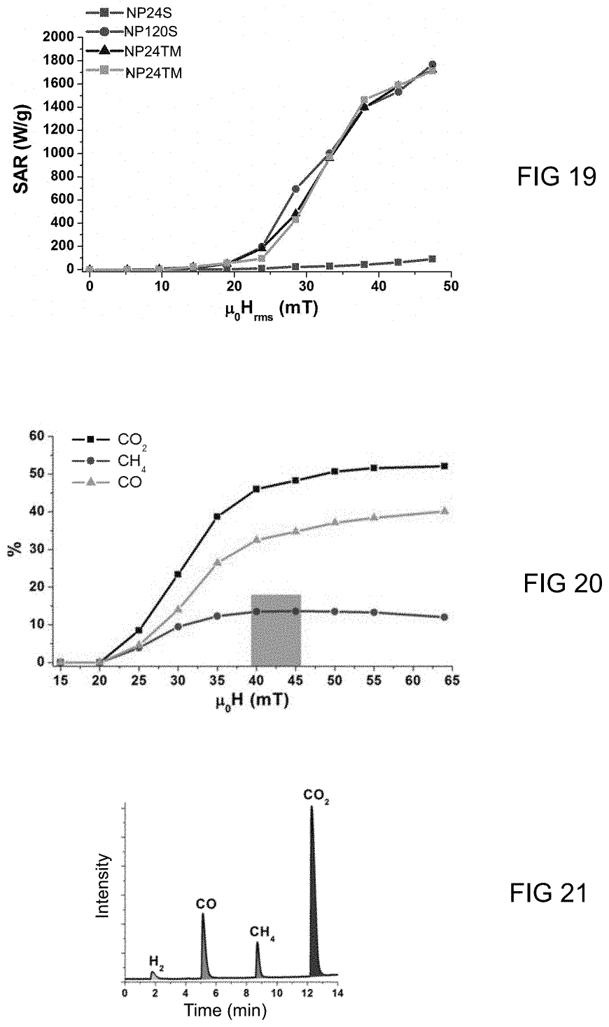

FIG. 19 represents a graph showing the specific absorption rate (SAR), as a function of the amplitude of the magnetic field, for a hyperthermia test by magnetic induction at 100 kHz carried out on iron carbide nanoparticles prepared: according to a method in accordance with the invention using, for the carburization step, a molecular sieve and a carburization time of 24 h (NP24TM, experiment carried out in duplicate) or no molecular sieve and a carburization time of 120 h (NP120S), or according to a method using a carburization time of 24 h without molecular sieve (NP24S);

FIG. 20 shows a graph representing, as a function of the amplitude of the magnetic field applied, the degree of conversion of carbon dioxide (CO₂) and the degree of formation of methane (CH₄) and degree of formation of carbon monoxide (CO) during the implementation of a method for catalysis of the Sabatier reaction according to the invention, carried out in continuous flow of reagents, using nickel-covered iron carbide nanoparticles supported on a solid support, in accordance with the invention;

FIG. 21 represents a gas chromatogram obtained at the outlet of the reactor during the implementation of the method of FIG. 20, for a magnetic field amplitude of 40 mT;

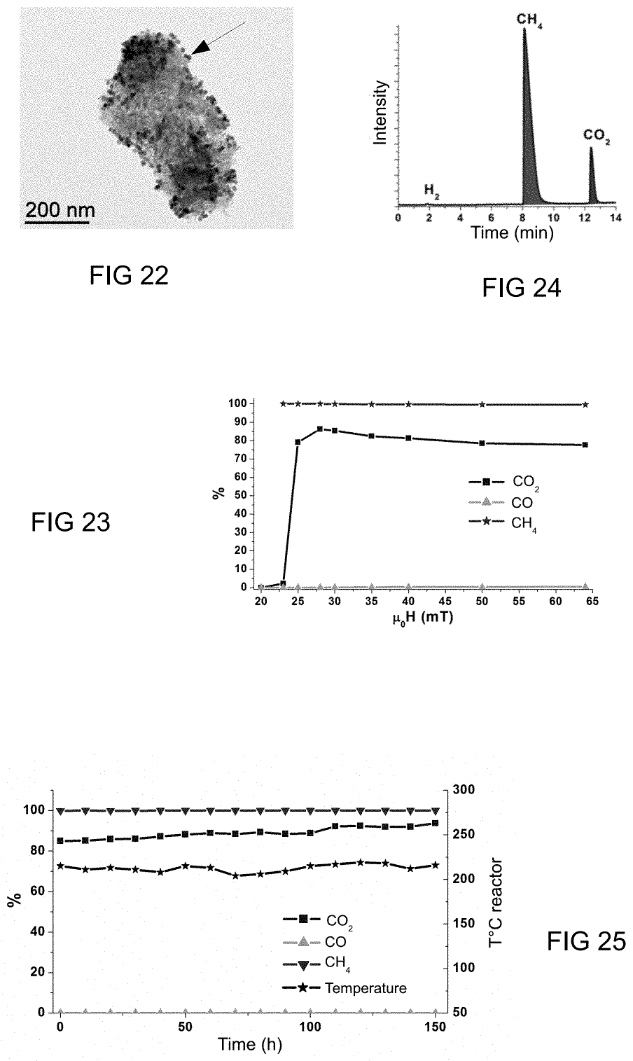

FIG. 22 shows an electron microscopy image of a grain of ruthenium-doped solid support supporting iron carbide nanoparticles in accordance with the invention;

FIG. 23 shows a graph representing, as a function of the amplitude of the magnetic field applied, the degree of conversion of carbon dioxide (CO₂) the degree of formation of carbon monoxide (CO) and the selectivity of formation of methane (CH₄) during the implementation of a method for catalysis of the Sabatier reaction according to the invention, carried out in continuous flow of reagents, using iron carbide nanoparticles covered and supported on a ruthenium-doped solid support, in accordance with the invention;

FIG. 24 represents a gas chromatogram obtained at the outlet of the reactor during the implementation of the method of FIG. 23, for a magnetic field amplitude of 28 mT;

and FIG. 25 represents a graph showing, as a function of time, the temperature change in the reactor, the degree of conversion of carbon dioxide (CO₂), the degree of formation of carbon monoxide (CO) and the selectivity of formation of methane (CH₄) during the implementation of the method of FIG. 23, at a magnetic field of amplitude 28 mT.

### A/ MATERIALS AND METHODS

All the syntheses of non-commercial compounds were carried out under argon using Fischer-Porter bottles, a glove box and a vacuum/argon line. The mesitylene (99%), toluene (99%) and tetrahydrofuran (THF, 99%) were purchased from VWR Prolabo, purified on alumina and gassed by means of three freezing-pumping-liquefying cycles. The commercial products hexadecylamine (HDA, 99%) and palmitic acid (PA) were purchased from Sigma-Aldrich. The bis(amido)iron(II) dimer {Fe[N(SiMe₃)₂]₂}₂ and the (1,5-cyclooctadiene)(1,3,5-cyclooctatriene)ruthenium(0) (Ru(COD)(COT)) were purchased from NanoMePS. The nickel(II)acetylacetonate was purchased from Sigma Aldrich. The 9.0 nm Fe(0) nanoparticles were either synthesized, or purchased from NanoMePS. All these compounds were used without additional purification.

The molecular sieve (0.4 nm pores, 2 mm diameter) was purchased from Merck (CAS 1318-02-1) and was activated under vacuum at 200° C. for 3 h. The Siralox® support was obtained from the company Sasol.

Characterization

The size and the morphology of the samples synthesized were characterized by transmission electron microscopy (TEM). The conventional microscopy images were obtained using a JeoL microscope (model 1400) operating at 120 kV. The X-ray diffraction (XRD) measurements were carried out on a PANalytical Empyrean diffractometer using a Co-Kα source at 45 kV and 40 mA. These studies were carried out on powdered samples prepared and sealed under argon. The mass spectrometry analyses were carried out on a Pfeiffer Vacuum Thermostar™ Gas Analysis System GSD 320 spectrometer. The state of the iron atoms and their environment was determined by Mössbauer spectroscopy (Wissel, 57Co source).

The gas chromatography coupled to mass spectrometry (GC-MS) analyses were carried out on a PerkinElmer 580 gas chromatograph coupled to a Clarus® SQ8T mass spectrometer. The carbon dioxide CO₂ conversion, the methane CH₄ yield, the carbon monoxide CO yield and the methane selectivity were calculated from the gas chromatograms, after calibration of the TCD detector. The magnetic measurements were carried out on a vibrating sample magnetometer (Quantum Device PPMS EverCool-II®). The nanoparticles were prediluted (100-fold) in tetracosane in order to eliminate the magnetic interactions.

### B/ SYNTHESIS OF ZERO-VALENT IRON NANOPARTICLES

General Protocol

In a glove box, the {Fe[N(SiMe₃)₂]₂}₂ iron precursor, the palmitic acid and the hexadecylamine are weighed separately in 15 ml sample holders and dissolved in mesitylene. The green solution containing the iron precursor is introduced into a Fischer-Porter bottle, followed by the palmitic acid and the hexadecylamine. The Fischer-Porter bottle is removed from the glove box and placed with stirring in an oil bath at 32° C. It is then purged of its argon and placed under a dihydrogen pressure of between 1 and 10 bar. The mixture is vigorously stirred at a temperature of between 120 and 180° C. for 1 to 72 h.

Once the reaction has ended, the Fischer-Porter bottle is removed from the oil bath and left to cool with stirring. Once at ambient temperature, it is placed in a glove box and degassed. The iron nanoparticles obtained are washed by magnetic decanting, three times with toluene and three times with THF. To finish, the iron nanoparticles are dried under a vacuum line. They are then characterized by transmission electron microscopy (TEM), X-ray diffraction (XRD), vibrating sample magnetometry (VSM) and elemental analysis (TGA).

### Example 1—Synthesis of 9.0 nm Fe⁰ Nanoparticles

The general protocol above is applied with the following parameters: the {Fe[N(SiMe₃)₂]₂}₂ iron precursor (1.0 mmol; 753.2 mg), the palmitic acid (1.2 equivalents/Fe, 2.4 mmol; 615.4 mg) and the hexadecylamine (1 equivalent/Fe, 2.0 mmol; 483.0 mg) are dissolved respectively in 5 ml, 10 ml and 5 ml of mesitylene.

The green solution containing the iron precursor is introduced into a Fischer-Porter bottle (rinsing of the sample holder with 5 ml of mesitylene), followed by the palmitic acid (rinsing of the sample bottle with 10 ml of mesitylene) and the hexadecylamine (rinsing of the sample holder with 5 ml of mesitylene). The Fischer-Porter bottle is closed, removed from the glove box and placed with stirring in an oil bath at 32° C. It is then purged of its argon and placed under a hydrogen pressure (2 bar). The mixture is vigorously stirred at 150° C. for 48 h.

The nanoparticles obtained, hereinafter referred to as FeNP1, are characterized. The results obtained by TEM and XRD are shown in FIG. 1, respectively in (a) and (b). It is observed that they are spherical, monodisperse, with a diameter D=9.0 nm+/−0.5 nm, and formed of an Fe⁰ bcc crystalline phase.

### Example 2—Synthesis of 12.5 nm Fe⁰ Nanoparticles

The general protocol above is applied with the following parameters: the {Fe[N(SiMe₃)₂]₂}₂ iron precursor (1.0 mmol; 753.2 mg), the palmitic acid (1.3 equivalents/Fe, 2.6 mmol; 666.4 mg) and the hexadecylamine (1 equivalent/Fe, 2.0 mmol; 483.0 mg) are dissolved respectively in 5 ml, 10 ml and 5 ml of mesitylene. The subsequent steps are carried out in accordance with example 1 above. The remainder of the synthesis and also the purification and the characterization are continued as in example 1.

The nanoparticles obtained, hereinafter referred to as FeNP2, are characterized. The results obtained by TEM and XRD are shown in FIG. 2, respectively in (a) and (b). It is observed that they are spherical, monodisperse, with a diameter D=12.5 nm+/−0.7 nm, and formed of an Fe⁰ bcc crystalline phase.

### C/ SYNTHESIS OF IRON CARBIDE NANOPARTICLES

General Protocol

In a glove box, the Fe⁰ nanoparticles are placed in a Fischer-Porter bottle and redispersed in mesitylene. The Fischer-Porter bottle is closed and removed from the glove box, purged of its argon and then placed under a carbon monoxide (between 1 and 10 bar) and hydrogen (between 1 and 10 bar) pressure. The mixture is then vigorously stirred at 120-180° C. for a period of between 1 min and 200 h.

Once the reaction has finished, the Fischer-Porter bottle is removed from the oil bath and left to cool with stirring. Once at ambient temperature, it is placed in a glove box and degassed. The nanoparticles obtained are washed, by magnetic washing, 3 times with toluene, then dried under a vacuum line. The black powder obtained is analyzed by TEM, XRD, VSM, Mössbauer spectroscopy and elemental analysis.

### Example 3—Synthesis of 13.0 nm Iron Carbide Nanoparticles Containing 83% of the Fe_{2.2}C Crystalline Structure

The general protocol above is applied with the following parameters: the Fe⁰ nanoparticles obtained in example 2 above (1 mmol Fe; 100 mg) are placed in a Fischer-Porter bottle and redispersed in mesitylene (20 ml). The Fischer-Porter bottle is placed under a carbon monoxide (2 bar) and hydrogen (2 bar) pressure. The mixture is then vigorously stirred at 150° C. for 120 h.

The nanoparticles obtained, hereinafter referred to as FeCNP1, are characterized. The results obtained by TEM (at two different magnifications), XRD and Mössbauer spectroscopy are shown in FIG. 3, respectively in (a), (b), (c) and (d). It is observed that the nanoparticles are spherical, monodisperse, with a diameter D=13.1 nm+/−1.1 nm, and that they comprise a monocrystalline Fe_{2.2}C core. It emerges from the Mössbauer spectroscopy that their content is 83 mol % Fe_{2.2}C and 17 mol % Fe₅C₂. The results of VSM at 300 K also indicate a magnetization at saturation Ms of approximately 151 emu/g.

### Example 4—Synthesis of 15.0 nm Iron Carbide Nanoparticles Containing 82% of the Fe_{2.2}C Crystalline Structure

The general protocol above is applied with the following parameters: the Fe⁰ nanoparticles obtained in example 2 above (1 mmol Fe; 100 mg) are placed in a Fischer-Porter bottle and redispersed in mesitylene (20 ml). The Fischer-Porter bottle is closed and removed from the glove box, purged of its argon and then placed under a carbon monoxide (2 bar) and hydrogen (2 bar) pressure. The mixture is then vigorously stirred at 150° C. for 140 h.

The nanoparticles obtained, hereinafter referred to as FeCNP2, are characterized. The results obtained by TEM, XRD and Mössbauer spectroscopy are shown in FIG. 4, respectively in (a), (b) and (c). It is observed that the nanoparticles are spherical, monodisperse, with a diameter D=15.0 nm+/−0.9 nm, and that they comprise a monocrystalline Fe_{2.2}C core. It emerges from the Mössbauer spectroscopy that their molar content is 82% Fe_{2.2}C and 18% Fe₅C₂. The results of VSM at 300 K also indicate a magnetization at saturation Ms of approximately 170 emu/g.

### Examples 5-7

Iron carbide nanoparticles are prepared according to the general protocol above, for different carburization times.

The operating parameters used are the following: the Fe⁰ nanoparticles obtained in example 1 or example 2 above (1 mmol Fe; 100 mg) are placed in the Fischer-Porter bottle and redispersed in mesitylene (20 ml). The Fischer-Porter bottle is placed under a carbon monoxide (2 bar) and hydrogen (2 bar) pressure. The mixture is then vigorously stirred at 150° C. for a carburization time t.

The nanoparticles obtained are characterized. It is verified, by XRD analysis, that the core consists exclusively of Fe_{2.2}C. Their molar content of Fe_{2.2}C is, moreover, determined by Mössbauer spectroscopy.

The characteristics of the nanoparticles thus prepared and the operating parameters used for the preparation thereof are reiterated in table 1 below.

TABLE 1
characteristics of nanoparticles according to the invention
and operating parameters for the preparation thereof

| | | Carburization | Nanoparticle |
|---|---|---|---|
| Reference | Fe⁰ nanoparticles | time t (h) | diameter (nm) |
| FeCNP3 | FeNP1 | 72 | 12.1 |
| FeCNP4 | FeNP1 | 96 | 13.1 |
| FeCNP5 | FeNP1 | 144 | 13.3 |

### Comparative Example 1—Synthesis of 9.7 nm Iron Carbide Nanoparticles Containing 59% of the Fe_{2.2}C Crystalline Structure

The general protocol above is applied with the following parameters: the Fe0 nanoparticles obtained in example 1 above (1 mmol Fe; 100 mg) are placed in a Fischer-Porter bottle and redispersed in mesitylene (20 ml). The Fischer-Porter bottle is placed under a carbon monoxide (2 bar) and hydrogen (2 bar) pressure. The mixture is then vigorously stirred at 150° C. for 24 h.

The nanoparticles obtained, hereinafter referred to as FeCcomp2, are characterized. The results obtained by TEM, XRD and Mössbauer spectroscopy are shown in FIG. 5, respectively in (a), (b) and (c). It is observed that the nanoparticles are spherical, monodisperse, with a diameter D=9.7 nm+/−0.5 nm, and that they comprise a monocrystalline Fe_{2.2}C core. It emerges from the Mössbauer spectroscopy that their molar content is 59% Fe_{2.2}C, 16% Fe₅C₂, 21% Fe⁰ and 4% paramagnetic phase (amorphous). The results of VSM at 300 K also indicate a magnetization at saturation Ms of approximately 150 emu/g.

### Comparative Examples 2 to 9

Iron carbide nanoparticles are prepared according to the general protocol above, for carburization times of less than 72 h.

The operating parameters used are the following: the Fe⁰ nanoparticles obtained in example 1 or example 2 above (1 mmol Fe; 100 mg) are placed in the Fischer-Porter bottle and redispersed in mesitylene (20 ml). The Fischer-Porter bottle is placed under a carbon monoxide (2 bar) and hydrogen (2 bar) pressure. The mixture is then vigorously stirred at 150° C. for a carburization time t.

The nanoparticles obtained are characterized. It is established by XRD analysis that the core consists of Fe_{2.2}C or of a mixture of Fe_{2.2}C and Fe⁰. Their molar content of Fe_{2.2}C is, moreover, determined by Mössbauer spectroscopy.

The characteristics of the nanoparticles thus prepared and the operating parameters used for the preparation thereof are reiterated in table 2 below.

TABLE 2
characteristics of comparative nanoparticles and
operating parameters for the preparation thereof

| | Fe⁰ | Carburization | Core | Molar % of |
|---|---|---|---|---|
| Reference | nanoparticles | time t (h) | composition | Fe_{2.2}C |
| FeCcomp3 | FeNP1 | 48 | Fe_{2.2}C | — |
| FeCcomp4 | FeNP1 | 16 | Fe_{2.2}C + Fe⁰ | — |
| FeCcomp5 | FeNP1 | 8 | Fe_{2.2}C + Fe⁰ | — |
| FeCcomp6 | FeNP1 | 4 | Fe_{2.2}C + Fe⁰ | — |
| FeCcomp7 | FeNP1 | 2 | Fe_{2.2}C + Fe⁰ | — |
| FeCcomp8 | FeNP2 | 48 | Fe_{2.2}C + Fe⁰ | 67 |
| FeCcomp9 | FeNP2 | 15 | Fe_{2.2}C + Fe⁰ | — |
| FeCcomp10 | FeNP2 | 4 | Fe_{2.2}C + Fe⁰ | — |

### D/ SYNTHESIS OF NICKEL-COVERED IRON CARBIDE NANOPARTICLES

General Protocol

In a glove box, the iron carbide nanoparticles are placed in a Fischer-Porter bottle and redispersed in mesitylene. Palmitic acid is added in order to facilitate the redispersion of the nanoparticles and to improve their stability in solution. The Ni(acac)₂ (bis(acetylacetonate)nickel) nickel precursor previously dissolved in mesitylene is introduced into the Fischer-Porter bottle. The bottle is closed and removed from the glove box, then passed through ultrasound for 15 s to 10 min (preferably 1 min). The mixture is vigorously stirred under argon at 120-180° C. (preferably 150° C.) for 10 min to 4 h (preferably 1 h) in order to homogenize the solution. Finally, the Fischer-Porter bottle is placed under a hydrogen pressure of between 1 and 10 bar (preferably 3 bar). The mixture is vigorously stirred at 150° C. for a period of between 1 and 48 h (preferably for 24 h).

Once the reaction has ended, the Fischer-Porter bottle is removed from the oil bath and left to cool with stirring. Once at ambient temperature, it is passed through ultrasound for 15 s to 10 min (preferably 1 min) and then placed in a glove box. The nanoparticles are washed, by magnetic washing, three times with toluene and then dried under a vacuum line. The nanoparticles obtained are analyzed by TEM, XRD, VSM, high resolution transmission electron microscopy (HRTEM) and scanning transmission electron microscopy coupled to energy-dispersive X-ray spectroscopy (STEM-EDX).

### Example 8

The general protocol above is applied using the iron carbide nanoparticles obtained in example 4 above, with the operating parameters described below.

The nanoparticles (1 mmol; 80 mg) are redispersed in mesitylene (15 ml). Palmitic acid (0.5 mmol; 128.4 mg) is added. The Ni(acac)₂ nickel precursor (0.5 mmol; 129.3 mg), previously dissolved in mesitylene (10 ml+5 ml rinsing), is introduced into the Fischer-Porter bottle. The latter is closed, removed from the glove box and then passed through ultrasound for 1 min. The mixture is vigorously stirred under argon at 150° C. for 1 h. Finally, the Fischer-Porter bottle is placed under a hydrogen pressure (3 bar). The mixture is vigorously stirred at 150° C. for 24 h.

Once at ambient temperature, the Fischer-Porter bottle is passed through ultrasound for 1 min.

The nanoparticles obtained, hereinafter referred to as FeC@Ni1, are characterized. The results obtained by TEM, XRD and STEM-EDX are shown in FIG. 6, respectively in (a), (b) and (c1) (crude STEM image), (c2) (iron-targeted STEM-EDX image) and (c3) (nickel-targeted STEM-EDX image). It is observed that the nanoparticles are spherical, monodisperse, with a diameter D=15.2 nm+/−1.1 nm. The XRD analysis confirms the presence of the crystalline core consisting of Fe_{2.2}C, and shows the growth of nickel in metal form at the surface of the nanoparticles, and also the absence of nickel oxides. The STEM-EDX analysis confirms that the iron is concentrated in the core of the nanoparticles, and that the nickel is for its part present at the surface.

### E/ HYPERTHERMIA MEASUREMENTS BY MAGNETIC INDUCTION

General Protocol

In a glove box, 10 mg of nanoparticles are placed in a tube to which 0.5 ml of mesitylene is added. The tube is removed from the glove box and treated for 1 min with ultrasound in order to obtain a colloidal solution of nanoparticles. The tube is then placed in a calorimeter containing 2 ml of deionized water. The calorimeter is exposed to an alternating magnetic field (100 kHz, amplitude adjustable between 0 and 47 mT) for 40 seconds and the heating of the water is measured using two optical temperature probes. The temperature increase is determined by the mean slope of the function ΔT/Δt. To finish, the SAR (Specific Absorption Rate) is calculated by means of the following equation:

$$S A R = \frac{{\sum }_{i} {C}_{pi} {m}_{i}}{{m}_{Fe}} \frac{Δ T}{Δ t}$$

wherein: Cₚᵢ represents the heat capacity of the compound i (Cₚ=449 J kg⁻¹K⁻¹ for the Fe nanoparticles, Cₚ=1750 J kg⁻¹K⁻¹ for the mesitylene, Cₚ=4186 J kg⁻¹K⁻¹ for the water and Cₚ=720 J kg⁻¹K⁻¹ for the glass); mᵢ represents the mass of the compound i; m_{Fe} represents the mass of iron in the sample.

Experiment 1

A first experiment is carried out for the Fe⁰ nanoparticles of example 2 (FeNP2) and the iron carbide nanoparticles of example 4 (FeCNP2).

By way of comparison, also tested, in parallel, are the iron carbide nanoparticles prepared in accordance with the protocol described in the publication by Meffre et al, 2012, Nanoletters, 4722-4728, of composition 43% Fe_{2.2}C, 43% Fe₅C₂, 14% paramagnetic species (FeCcomp1).

The results obtained are also compared to those presented for iron oxide nanoparticles in the publication by Pellegrino et al, 2014, J. Mater. Chem. B, 4426-4434, described for presenting a high SAR (FeONP).

The results obtained are shown in FIG. 7.

It is observed that the FeCNP2 nanoparticles in accordance with the invention exhibit hyperthermia performance levels which are very much better than those of the other nanoparticles.

Experiment 2

The maximum SARs obtained at 100 kHz, for a magnetic field of amplitude 47 mT, for the various nanoparticles below, are indicated in table 3 below.

TABLE 3
maximum SARs obtained at 100 kHz for nanoparticles in accordance
with the invention and comparative nanoparticles

| Nanoparticle | SARmax (W/g) |
|---|---|
| FeNP1 | 425 |
| FeCcomp6 | 1070 |
| FeCcomp5 | 450 |
| FeCcomp4 | 95 |
| FeCcomp3 | 890 |
| FeCcomp2 | 45 |
| FeCNP1 | 1630 |
| FeCNP3 | 1485 |
| FeNP2 | 1220 |
| FeCcomp9 | 660 |
| FeCcomp8 | 100 |
| FeCNP2 | 3300 |

It is observed that the nanoparticles in accordance with the invention all have SARs much higher than those of the comparative nanoparticles, and than those of the zero-valent iron nanoparticles having served to prepare them.

Experiment 3

The FeNP1 zero-valent iron nanoparticles, the iron carbide nanoparticles in accordance with the invention (FeCNP1, FeCNP3, FeCNP4 and FeCNP5) and the comparative iron carbide nanoparticles (FeCcomp2, FeCcomp3, FeCcomp4, FeCcomp6, FeCcomp7), obtained using these FeNP1 nanoparticles, are subjected to the test protocol below. The SAR is measured for various magnetic field amplitudes.

The results obtained are shown in FIG. 8.

It is observed that not only do the nanoparticles according to the invention have much higher SARs than the comparative nanoparticles, but in addition, their hyperthermia performance levels are exerted at magnetic fields of low amplitude, as early as 25 mT for some of them. These performance levels are high starting from approximately 38 mT for all the nanoparticles in accordance with the invention.

Experiment 4

The FeNP2 zero-valent iron nanoparticles, the iron carbide nanoparticles in accordance with the invention (FeCNP2) and the comparative iron carbide nanoparticles (FeCcomp8, FeCcomp9, FeCcomp10), obtained from these FeNP2 nanoparticles, are subjected to the test protocol above. The SAR is measured for various magnetic field amplitudes.

The results obtained are shown in FIG. 9.

It is observed that not only do the nanoparticles according to the invention have a much higher SAR than the comparative nanoparticles, but in addition, their hyperthermia performance levels are exerted at magnetic fields of low amplitude, and are particularly high as early as approximately 25 mT.

Experiment 5—Influence of the Nanoparticle Size

The SARs of the FeCNP1 (diameter approximately 13 nm) and FeCNP2 (diameter approximately 15 nm) nanoparticles in accordance with the invention are subjected to the test protocol above.

The results obtained are shown in FIG. 10.

It is observed that the two types of nanoparticles have a high heating capacity, the nanoparticles of approximately 15 nm in size being, however, more effective than the nanoparticles of approximately 13 nm in size.

Experiment 6

The SARs of the FeCNP2 and FeC@Ni nanoparticles in accordance with the invention are subjected to the test protocol above.

The results obtained are shown in FIG. 11.

It is observed that the nickel-covered nanoparticles have a heating capacity substantially equivalent to that of the non-covered nanoparticles for magnetic fields above 40 mT.

### F/ CATALYSIS OF THE SABATIER REACTION BY MAGNETIC INDUCTION

General Protocol The iron carbide nanoparticles are used to catalyze the Sabatier reaction, according to the reaction scheme:

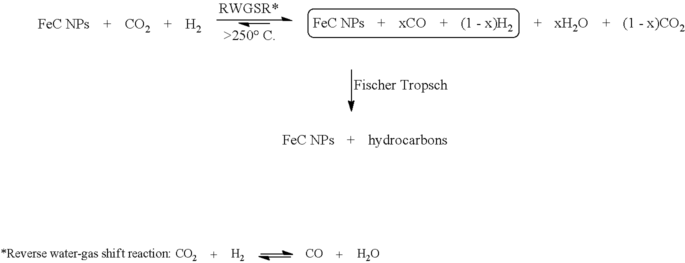

in which FeC NPs represents the iron carbide nanoparticles.

For this purpose, in a glove box, the catalyst in powder form (10 mg) is placed in a Fischer-Porter bottle fitted at its head with a manometer in order to monitor the pressure variation during the reaction, without any solvent. The Fischer-Porter bottle is closed, removed from the glove box, emptied of its argon and placed under a CO₂ (1 equivalent; 0.8 bar: from −1 bar to −0.2 bar) and H₂ (4 equivalents; 3.2 bar: from −0.2 bar to 3 bar) pressure. The Fischer-Porter bottle is then exposed to an alternating magnetic field (300 kHz, amplitude adjustable between 0 and 64 mT) for 8 h. At the end of the reaction, the gas phase is analyzed by mass spectrometry in order to identify the compounds formed.

Experiment 1

The FeCNP2 iron carbide nanoparticles in accordance with the invention are used in this experiment. The results obtained, in terms, on the one hand, of degree of CO₂ conversion and, on the other hand, of yield of hydrocarbon(s), as a function of the amplitude of the magnetic field applied, are shown in FIG. 12. These results show that the degree of CO₂ conversion is close to 100% at magnetic field amplitudes even of less than 30 mT. The yield of hydrocarbon(s) is very high, about 80% above 30 mT, this being without having recourse to doping with another element such as cobalt or ruthenium.

The mass spectrum obtained for the gas phase at 30 mT is shown in FIG. 13. It is observed therein that methane (CH₄) is the compound very predominantly formed.

Thus, the iron carbide nanoparticles in accordance with the invention have a very good catalytic activity at a field greater than or equal to 30 mT. The methane selectivity is also very high, approximately 80%.

Experiment 2

The FeC@Ni nickel-covered iron carbide nanoparticles in accordance with the invention and the FeCNP2 iron carbide nanoparticles in accordance with the invention are used in this experiment.

The operating protocols differ from that previously described in regard to the duration of application of the magnetic field and the amplitude of the latter.

The exact operating parameters and the associated results, in terms of degree of CO₂ conversion, of yield of hydrocarbon(s) and of selectivity with respect to methane, are indicated in table 4 below.

TABLE 4
operating parameters and results of the catalysis
of the Sabatier reaction by magnetic induction of
nanoparticles in accordance with the invention

| | Duration of | | | |
|---|---|---|---|---|
| | induction | Degree of | | |
| | and amplitude | CO₂ conver- | Hydrocarbon | Selectivity/ |
| Nanopart. | of the field | sion (%) | yield (%) | methane (%) |
| FeC@Ni | 3 h at 64 mT | 84 | 74 | 97 |
| FeC@Ni | activation for 5 s | 36 | 27 | >99 |
| | at 64 mT then 8 h | | | |
| | at 25 mT | | | |
| FeCNP2 | 8 h at 64 mT | >98 | 76 | 80 |

It is deduced therefrom that:
for the nickel-covered nanoparticles, the reaction is virtually quantitative in 3 h at 64 mT, and the methane selectivity is virtually total. It also emerges from the mass spectrum (not shown) that the carbon dioxide is quantitatively converted, on the one hand, into methane and, on the other hand, into a small amount of carbon monoxide;
at the same magnetic field amplitude, the nickel-covered nanoparticles make it possible to achieve similar hydrocarbon yields, and a greater methane selectivity, compared with the non-covered nanoparticles, this being in much shorter times;
for the nickel-covered nanoparticles, after activation for a few seconds at 64 mT, then 8 h at 25 mT, a catalytic activity is observed, although at the value of 25 mT, the SAR of the nanoparticles is zero (cf. FIG. 11). This demonstrates that it is possible to catalyze the Sabatier reaction with a low energy consumption, by means of a very short first phase of activation at a high magnetic field, followed by a phase at a magnetic field of much lower amplitude.

Thus, in the case of the nickel-covered iron carbide nanoparticles, it is possible to activate the reaction at a strong field (64 mT) for a few seconds and then to work at a weak field (25 mT) for several hours. Since the reaction is exothermic, once initiated, it is advantageously possible to maintain it at low energy cost.

By way of comparison, the same protocol was applied for iron carbide nanoparticles of the prior art (containing 43% of Fe_{2.2}C, prepared according to the publication by Meffre et al., 2012, Nanoletters, 12, 4722-4728). No catalytic activity was observed for these nanoparticles.

Experiment 3

The FeCNP1 iron carbide nanoparticles in accordance with the invention are used in this experiment. The amplitude of the magnetic field is set at 40.2 mT.

The mass spectrum obtained for the gas phase at the end of the reaction is shown in FIG. 14. A degree of CO₂ conversion of approximately 55% and a hydrocarbon yield of approximately 37% are deduced from said spectrum, methane being the compound principally formed.

At the end of the reaction, the nanoparticles are analyzed by DRX. The diffractogram obtained is shown in FIG. 15. When it is compared with the XR refractogram of the nanoparticles before catalysis, shown in FIG. 3(c), it is noted that the nanoparticles have undergone only a very slight modification of their structure during the reaction. The catalyst comprising the nanoparticles can be reused several times without loss of activity.

The description above clearly demonstrates that the iron carbide nanoparticles in accordance with the invention have the capacity to catalyze the Sabatier reaction by magnetic induction. For the nanoparticles tested, a total conversion of carbon dioxide at 30 mT and 300 kHz is obtained, this being without using any additional catalyst. Under the conditions tested, only a slight modification of the catalyst is observed.

### G/ COMPARATIVE MEASUREMENTS OF HYPERTHERMIA BY MAGNETIC INDUCTION

Synthesis of Iron Carbide Nanoparticles

Iron carbide nanoparticles are prepared, with the following various carburization times, from the same batch of 12.5 nm Fe⁰ nanoparticles, obtained in example 2 above.

The general protocol is that described in example 4 above, with only the carburization time varying, it being equal to 48 h (NP48 nanoparticles), 96 h (NP96 nanoparticles) or 140 h (NP140 nanoparticles).

The Mössbauer spectra for each of these nanoparticles are shown in FIG. 16. The compositions for the nanoparticles indicated in table 5 below are deduced from said Mössbauer spectra. The NP96 and NP140 nanoparticles are in accordance with the invention, while the NP48 nanoparticles are not in accordance with the invention, because they have an insufficient molar content of Fe_{2.2}C.

The hyperthermia properties of these nanoparticles were analyzed as described in example E/ above. The curves showing, for each one, the SAR as a function of the amplitude of the magnetic field, are shown in FIG. 17. The maximum SARs for each are indicated in table 5 below.

TABLE 5
Composition and maximum SAR for iron carbide
nanoparticles in accordance (NP96, NP140)
or not in accordance with the invention

| Nanoparticle | Composition | SARmax (W/g) |
|---|---|---|
| Fe⁰ | — | 650 |
| NP48 | 54% Fe_{2.2}C, 23% Fe₅C₂, | 460 |
| | 18% Fe(0), 5% others | |
| NP96 | 72% Fe_{2.2}C, 24% Fe₅C₂, | 2120 |
| | 4% Fe(0) | |
| NP140 | 83% Fe_{2.2}C, 17% Fe₅C₂ | 3220 |

It is observed that the NP96 and NP140 nanoparticles in accordance with the invention exhibit hyperthermia performance levels that are much better than those of other nanoparticles (NP48).

### H/ SYNTHESIS OF IRON CARBIDE NANOPARTICLES WITH WATER REMOVAL

General Protocol

In a glovebox, the Fe⁰ nanoparticles are placed in a Fischer-Porter bottle and redispersed in mesitylene. The upper part of the Fischer-Porter bottle used has a cartridge of glass grafted to the wall (Fischer-Porter bottle manufactured by the company Avitec) into which is introduced pre-activated molecular sieve (approximately 1.5 g). The molecular sieve is not in contact with the nanoparticle solution, and remains at a moderate temperature. The Fischer-Porter bottle is closed and removed from the glovebox, purged of its argon and then placed under a carbon monoxide (between 1 and 10 bar) and hydrogen (between 1 and 3 bar) pressure in order to obtain an overpressure of 3 bar in the bottle. The mixture is then vigorously stirred at 120-180° C. for 1 min to 200 h.

Once the reaction has ended, the Fischer-Porter bottle is removed from the oil bath and left to cool with stirring. Once at ambient temperature, it is placed in a glovebox and degassed. The nanoparticles are washed, via magnetic washing, three times with toluene and then dried under a vacuum line. The black powder obtained is analyzed by TEM, XRD, VSM and elemental analysis.

### Example 9—Starting from 12.5 nm Fe⁰ Nanoparticles

In a glovebox, the Fe⁰ nanoparticles (12.5 nm; 1 mmol Fe; 100 mg), prepared in example 2, are placed in the Fischer-Porter bottle and redispersed in mesitylene (20 ml). The Fischer-Porter bottle is placed under a carbon monoxide (2 bar) and hydrogen (2 bar) pressure. The mixture is then vigorously stirred at 150° C. for 40 h.

By way of comparison, the same experiment is carried out in parallel without molecular sieve, over the course of periods of 48 h and 140 h.

After a reaction time of 16 h, a sample of the nanoparticles is taken and analyzed by XRD. No presence of Fe(0) is any longer seen. For the same experiment carried out in parallel without molecular sieve, after 16 h, a composition of approximately 50% of Fe(0) and 50% of Fe_{2.2}C is obtained. This confirms that the use of the molecular sieve, making it possible to remove the water as it is formed in the reaction, has the effect of accelerating the carburization reaction.

After 40 h of reaction, nanoparticles comprising a molar content, determined by Mössbauer analysis, of greater than 75% of Fe_{2.2}C are obtained for the experiment with molecular sieve.

For each of the experiments with and without molecular sieve, the hyperthermia properties of the nanoparticles obtained are analyzed as described in example E/ above. The curves presenting, for each one, the SAR as a function of the amplitude of the magnetic field, are shown in FIG. 18. It is observed that, for the experiment with molecular sieve (NP40TM), performance levels are obtained over the course of 40 h that are as high as those obtained over the course of 140 h in the absence of molecular sieve (NP140S).

### Example 10—Starting from 9.0 nm Fe⁰ Nanoparticles

In a glovebox, Fe⁰ nanoparticles (9.0 nm; 1 mmol Fe; 100 mg) (of commercial origin) are placed in the Fischer-Porter bottle and redispersed in mesitylene (20 ml). The Fischer-Porter bottle is placed under a carbon monoxide (2 bar) and hydrogen (2 bar) pressure. The mixture is then vigorously stirred at 150° C. for 24 h. This experiment is carried out in duplicate.

By way of comparison, the term experiment is carried out in parallel without molecular sieve, over the course of periods of 24 h and 120 h.

After 24 h of reaction, nanoparticles comprising a molar content, determined by Mössbauer analysis, of greater than 75% of Fe_{2.2}C are obtained for the experiment with molecular sieve.

For each of the experiments with and without molecular sieve, the hyperthermia properties of the nanoparticles obtained are analyzed as described in example E/ above. The curves showing, for each one, the SAR as a function of the amplitude of the magnetic field are shown in FIG. 19. It is observed that, for the experiments with molecular sieve (NP24TM), performance levels are obtained over the course of 24 h that are as high as those obtained over the course of 120 h in the absence of molecular sieve (NP120S).

### I/ SYNTHESIS OF SIRALOX®-SUPPORTED NICKEL-COVERED IRON CARBIDE NANOPARTICLES

Synthesis of Ruthenium-Doped Siralox®

In a glovebox, the Siralox® (800 mg) is added to an orange solution of Ru(COD)(COT) (120.0 mg, 0.38 mmol) in mesitylene (5 ml). The mixture is stirred under argon at ambient temperature for 1 h, then placed under a dihydrogen (3 bar) pressure and stirred at ambient temperature for 24 h. At the end of the reaction, the powder is recovered by decanting and washed three times with toluene (3×5 ml). The ruthenium Ru-doped Siralox® is then dried under vacuum. According to the elemental analyses, it contains 1% by weight of Ru.

Synthesis of the Siralox®-Supported Nanoparticles

In a glovebox, the magnetic nanoparticles (FeC@Ni1 of example 8 or FeCNP2 of example 4) (100 mg, i.e. approximately 75 mg of Fe) are dispersed in toluene (5 ml). The Siralox® (Sir) or the Ru-doped Siralox® as described above (RuSir) (700 mg) is added to the solution, and the resulting mixture is exposed to ultrasound (outside the glovebox) for approximately 1 min. The Fischer-Porter bottle is again placed in the glovebox, and the supernatant is removed after decanting. The black powder obtained is dried under vacuum. A load at approximately 10% by weight of Fe on the Siralox® is obtained.

### J/ CATALYSIS OF THE SABATIER REACTION IN A CONTINUOUS-FLOW REACTOR

General Protocol

In a glovebox, the supported catalyst (800 mg) is loaded, in powder form, into a glass reactor (1 ml, 1 cm×0.8 cm). The reactor is then connected to the catalysis equipment, placed at the center of an induction coil, and fed with a flow of H₂ and CO₂ controlled by mass flows (H₂/CO₂ ratio=4, stoichiometric). For a standard test, the total flow rate is set at 25 ml·min⁻¹ (hourly space velocity HSV=1500 h⁻¹). The reactor, placed at the center of the induction coil, is exposed to alternating magnetic fields of frequency 300 kHz and of amplitudes of between 0 and 64 mT. At the reactor outlet, the gases are directly analyzed by GC-MS.

### Example 11—Sir-Supported FeC@Ni1 Nanoparticles

The degree of CO₂ conversion, of CH₄ formation and of CO formation, as a function of the amplitude of the magnetic field, which are measured after 2 hours of reaction, are shown in FIG. 20. It is observed that the CO₂ conversion occurs at a high degree of conversion. In addition, from the point of view of the CH₄ formation, the optimum amplitude is in the region of 40 mT (shaded area on the figure). It is associated with a CH₄ yield of approximately 14%. Beyond this, the more the amplitude of the magnetic field increases, the more the CO yield increases and the CH₄ yield decreases.

The gas chromatogram obtained at the outlet of the reactor, for the amplitude of 40 mT, is shown in FIG. 21. It confirms the presence of CH₄ at the outlet of the reactor.

### Example 12—RuSir-Supported FeCNP2 Nanoparticles

In this example, the FeCNP2 nanoparticles according to the invention, on the ruthenium-doped Siralox® support, are used. An electron microscopy image of a grain of powder obtained as described in example I/ is shown in FIG. 22. It confirms the presence of the iron carbide nanoparticles at the surface of the grain, in the form of black balls, one of which is indicated by the arrow on the figure.

The degree of CO₂ conversion, of selectivity with respect to CH₄ and of CO formation, as a function of the amplitude of the magnetic field, which are measured after 2 hours of reaction, are shown in FIG. 23. A high degree of CO₂ conversion is observed as soon as there is a magnetic field amplitude of 25 mT. In addition, the selectivity with respect to CH₄ formation is particularly strong, close to 100%. The optimum amplitude is in the range of from 25 to 30 mT (shaded area on the figure). It is associated with a CH₄ yield of approximately 86%.

The gas chromatogram obtained at the outlet of the reactor, for the amplitude of 28 mT, is shown in FIG. 24. It confirms the very predominant presence of CH₄ at the outlet of the reactor.

These results demonstrate that the nanoparticles in accordance with the invention make it possible to carry out the catalysis of the Sabatier reaction, in a continuous-flow operating mode, with high yields and total selectivity for methane formation.

Similar results are obtained for total flow rates in the range of from 25 to 125 ml/min.

The experiment is continued for 150 h under a magnetic field of 28 mT, while regularly evaluating the degrees of CO₂ conversion, of selectivity with respect to CH₄ and of CO formation, and also the temperature in the reactor. The curves obtained for these various parameters, as a function of time, are shown in FIG. 25. They confirm that the heating capacity of the nanoparticles according to the invention, and the catalytic activity, are stable after a period of time as long as 150 hours of continuous-flow reaction. This proves to be all the more advantageous since the operation of the magnetic field inducer was interrupted several times during the experiment, demonstrating an ability of the nanoparticles according to the invention to operate intermittently.

1-25. (canceled)

26. An iron carbide nanoparticle, wherein at least 70% of the iron atoms that it comprises are present in an Fe_{2.2}C crystalline structure.

27. The iron carbide nanoparticle as claimed in claim 26, wherein at least 80% of the iron atoms that it comprises are present in an Fe_{2.2}C crystalline structure.

28. The iron carbide nanoparticle as claimed in claim 26, having a size of between 1 and 20 nm.

29. The iron carbide nanoparticle as claimed in claim 26, having a size equal to 15 nm±1 nm.

30. The iron carbide nanoparticle as claimed in claim 26, covered on at least part of its surface with a coating of a catalytic metal.

31. The iron carbide nanoparticle as claimed in claim 30, wherein said catalytic metal is chosen in the group consisting of nickel, ruthenium, cobalt, copper, zinc, platinum, palladium, rhodium, manganese, molybdenum, tungsten, vanadium, iridium, gold, or any one of the alloys thereof, alone or as a mixture.

32. The iron carbide nanoparticle as claimed in claim 26, obtainable by means of a step of carburization of a zero-valent iron nanoparticle by bringing said zero-valent iron nanoparticle into contact with a gas mixture of dihydrogen and carbon monoxide.

33. The iron carbide nanoparticle as claimed in claim 26, supported on a solid support.

34. A preparation method for preparing iron carbide nanoparticles as claimed in claim 26, comprising a step of carburization of zero-valent iron nanoparticles by bringing said zero-valent iron nanoparticles into contact with a gas mixture of dihydrogen and carbon monoxide.

35. The preparation method as claimed in claim 34, wherein said carburization step is carried out at a temperature of between 120 and 300° C.

36. The preparation method as claimed in claim 34, wherein said carburization step is carried out for a period of between 72 and 200 h.

37. The preparation method as claimed in claim 34, wherein said carburization step comprises the removal of the water formed during the reaction of said zero-valent iron nanoparticles and of said gas mixture, as said water is formed.

38. The preparation method as claimed in claim 34, comprising a prior step of preparing the zero-valent iron nanoparticles by decomposition of an organometallic precursor corresponding to general formula (I):
Fe(NR¹R²)(NR³R⁴) (I)
wherein R¹, R², R³ and R⁴, which may be identical or different, each represent an alkyl, aryl, trimethylsilyl or trimethylalkyl group,
in the presence of dihydrogen and of a ligand system comprising a carboxylic acid and an amine, at least one of said carboxylic acid and of said amine comprising a C₈ to C₂₀ hydrocarbon-based chain.

39. The preparation method as claimed in claim 38, wherein said ligand system comprises palmitic acid and/or hexadecylamine.

40. The preparation method as claimed in claim 39, wherein said carburization step is carried out directly on the zero-valent iron nanoparticles obtained at the end of said decomposition step.

41. The preparation method as claimed in claim 38, wherein said decomposition step is carried out at a temperature of between 120 and 300° C.

42. The preparation method as claimed in claim 38, wherein said decomposition step is carried out for a period of between 1 and 72 h.

43. The preparation method as claimed in claim 34, comprising a subsequent step of treating the iron carbide nanoparticles obtained at the end of said carburization step, by bringing said iron carbide nanoparticles into contact with a precursor of a catalytic metal, so as to form a coating of said catalytic metal at the surface of said iron carbide nanoparticles.

44. A method for heat production comprising a step of using iron carbide nanoparticles as claimed in claim 26.

45. A method for the catalysis of chemical reaction comprising a step of using iron carbide nanoparticles as claimed in claim 26.

46. The method as claimed in claim 45, comprising a step of using said iron carbide nanoparticles for the catalysis of a reaction for reduction of carbon dioxide or of carbon monoxide into hydrocarbon(s).

47. A catalysis method for catalyzing a chemical reaction by means of iron carbide nanoparticles as claimed in claim 26, wherein said nanoparticles are introduced into a reaction medium containing one or more reagents for said chemical reaction, and said reaction medium is subjected to a magnetic field capable of causing an increase in the temperature of said nanoparticles up to a temperature of greater than or equal to a temperature required for carrying out said chemical reaction.

48. The catalysis method as claimed in claim 47, wherein the magnetic field is applied at a first amplitude for a first period of time, then at a second amplitude, of less than said first amplitude, for a second period of time, said second period of time being longer than said first period of time.

49. The catalysis method as claimed in claim 47, wherein the magnetic field is applied to said reaction medium in a pulsed manner.

50. The catalysis method as claimed in claim 47, wherein said nanoparticles are supported on a solid support, and said chemical reaction is carried out in a flow of continuous reagent(s).
